(19) United States
(12) Patent Application Publication
(10) Pub. No.: US 2026/0303699 A1
(43) Pub. Date: Oct. 1, 2026

(54) SYSTEMS AND METHODS FOR SERVICE DISCOVERY ON A COMMUNICATION NETWORK

(71) Applicant: Apple Inc., Cupertino, CA (US)

(72) Inventors: Venkateswara Rao Manepalli, San Jose, CA (US); Edward William Yawton Lemon, III, Utrecht (NL); Vidyuth Chikoti, Newark, CA (US)

(21) Appl. No.: 19/578,829

(22) Filed: Mar. 25, 2026

Related U.S. Application Data
(60) Provisional application No. 63/778,300, filed on Mar. 26, 2025.

(51) Int. Cl. H04L 67/51; H04W 60/00

(52) U.S. Cl. CPC H04L 67/51; H04W 60/00

(57) ABSTRACT

Embodiments described herein relate to techniques for discovery and/or access of services associated with the accessory devices on a wireless mesh network. An electronic device may employ a service registration module to enable communication with the accessory devices in an environment. The service registration module may include a Service Registration Protocol server with a cache to store services associated with the accessory devices. The electronic device provides either a service associated with an accessory device (e.g., the accessory device is a non-routing device) or each of the services stored in the cache (e.g., the accessory device is a routing device) and on the wireless mesh network for discovery. Further, the electronic device refrains from enabling registration of the service based on the service being already stored in the cache. Moreover, the electronic device performs an automatic service registration based on a one-to-one connection with the accessory device.

### CROSS-REFERENCE TO RELATED APPLICATIONS

This application claims priority to U.S. Provisional Patent Application No. 63/778,300 entitled “Systems and Methods for Service Discovery on a Communication Network,” filed on Mar. 26, 2025, which is hereby incorporated by reference in its entirety for all purposes .

### BACKGROUND

The present disclosure relates generally to wireless communication, and more specifically to discovery and/or access of services associated with devices on a wireless mesh network.

An electronic device may communicate with accessory devices on a wireless mesh network (e.g., Thread network) by employing an application (e.g., Matter) module, a network protocol (e.g., Thread) module), and/or a service registration module. The application module may request device information (e.g., Internet Protocol (IP) address, service instance identifier) of an accessory device from the service registration module to communicate with the accessory device. However, when a server of the service registration module becomes available on the wireless mesh network, all accessory devices on the wireless mesh network may register to the server of the service registration module in a same time period. This near concurrent or simultaneous registration may cause network congestion and an increase in latency, which may delay delivery of application-layer communications resulting in latency that impacts a user experience.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. This disclosure may encompass a variety of aspects that may not be set forth below.

In one embodiment, one or more tangible, non-transitory computer-readable media storing instructions that, when executed by processing circuitry of an electronic device, are configured to cause the processing circuitry to store a list of one or more services registered to one or more accessory devices in a cache of a server, cause the electronic device to communicatively couple with an accessory device on a wireless network, determine the accessory device is a routing device or a non-routing device, enable discovery of each of the one or more services in the list and connected to the wireless network based on the accessory device being the routing device, and enable discovery of a service of the one or more services associated with the accessory device based on the accessory device being the non-routing device.

In another embodiment, a method to be performed by processing circuitry includes identifying a service for discovery, determining that the service is stored in a cache of the electronic device, refraining from enabling registration of the service based on the service being stored in the cache, and enabling registration of the service based on the service not being stored in the cache.

In yet another embodiment, an electronic device includes a transmitter, a receiver, and processing circuitry coupled to the transmitter and the receiver, the processing circuitry configured to cause the electronic device to communicatively couple with an accessory device on a wireless network to establish a connection with the accessory device, determine whether the connection with the accessory device is a one-to-one connection, and determine whether a service associated with the accessory device is stored in a cache of the electronic device. The processing circuitry is also configured to perform an automatic registration of a service with a server based on the connection being the one-to-one connection and the service not being stored in the cache, refrain from performing the automatic registration of the service with the server based on the service being stored in the cache, and cause the transmitter to advertise the service based on the connection not being the one-to-one connection.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a wireless mesh network that may include the electronic device of FIG. 1, according to embodiments of the present disclosure;

FIG. 4 is a block diagram the electronic device of FIG. 1 having a service registration module with a cache to facilitate discovery of services corresponding to accessory devices on the wireless mesh network, according to embodiments of the present disclosure;

FIG. 5 is a block diagram of the electronic device of FIG. 1 including the service registration module with the cache to enable discovery of a service by a non-routing accessory device of FIG. 4, according to embodiments of the present disclosure;

FIG. 6 is a block diagram of the electronic device of FIG. 1 including the service registration module with the cache to enable discovery of each service on the wireless mesh network by a routing accessory device of FIG. 4, according to embodiments of the present disclosure;

FIG. 7 is a flow diagram of a process for the electronic device of FIG. 1 to enable discovery of the services via a cache, according to embodiments of the present disclosure;

FIG. 8 is a flow diagram of a process for the electronic device of FIG. 1 to identify whether service data associated with a service instance is stored in a cache, according to embodiments of the present disclosure; and

FIG. 9 is a flow diagram of a process for the electronic device of FIG. 1 to automatically perform service registration, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 % of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to techniques for discovery and/or access of services associated with accessory devices (e.g., Thread devices) on a wireless mesh network, such as a Thread network. For example, an electronic device may include a Thread on Mobile device that may employ a network (e.g., Thread) module, an application (e.g., Matter) module, and/or a service registration (e.g., a Service Registration Protocol (SRP)/Multicast Domain Name System (mDNS)) module to communicate with the accessory devices in an environment. The service registration module may facilitate discovery and/or registration of one or more services corresponding to the accessory devices on the wireless mesh network. For example, the service registration module may enable an SRP registration function, and the accessory devices may then register with the service registration module. The service registration module may include an SRP server that may store one or more services (e.g., list of the one or more services) in a cache of the SRP server. The service registration module may then provide one or more service instance identifiers associated with the one or more services from the cache to the accessory device to enable discovery of the one or more services.

As an example, the electronic device may establish a connection with the wireless mesh network. Further, the electronic device may establish a connection with an accessory device on the wireless mesh network. The accessory device may either include a routing device or not include a routing device. When the accessory device includes the routing device, the electronic device may enable discovery of each of the one or more services (e.g., for each of the accessory devices that are connected to the wireless mesh network) stored in the cache (e.g., by providing one or more service instance identifiers associated with the one or more service instances). When the accessory device does not include the routing device, such as a sleepy end device, the electronic device may enable discovery of the service associated with the accessory device (e.g., by providing a service instance identifier associated with the service instance). The accessory device may register one or more instances of each of the one or more services.

The service registration module may advertise an SRP service on the wireless mesh network. In this manner, the accessory devices may discover that the SRP service is available and register with the SRP server. For example, a particular accessory device may register service data (or service instance data) associated with a service instance of the particular accessory device with the SRP server. The service instance may include an instance (e.g., a specific, running occurrence) of the service on a device (e.g., an accessory device). However, several accessory devices may attempt to register with the SRP server in a same time period, which may cause network congestion and increase latency. Therefore, in some embodiments, the electronic device may identify whether a service instance identifier associated with a service instance is stored in the cache. For example, the application module of the electronic device may have a list of service instances to actuate, employ, or otherwise use, identify a desired service to perform discovery of, and/or establish a connection to the desired service. In some cases, the application module may communicate a request for service registration data from the SRP server to actuate, employ, or otherwise use a desired service instance of the list of service instances. For example, the application module may send a request for the service instance identifier of the desired service to the service registration module. The service registration module may then check the cache to identify whether the service data associated with the desired service is stored in the cache. For example, the service registration module may check the cache to identify whether a valid and/or applicable registration of the desired service is stored. If the service data associated with the desired service is stored in the cache, then the service registration module may refrain from advertising the SRP service. Alternatively, if the service data associated with the desired service is not stored in the cache, then the service registration module may advertise the SRP service.

As described herein, the electronic device may prompt registration of the services by advertising the SRP service. However, because advertising the SRP service may cause various accessory devices to attempt to register with the SRP service simultaneously, network congestion may occur. Therefore, the electronic device may experience latency and network overhead for communication on the wireless mesh network. Moreover, the network congestion may cause delays in availability of information associated with or required in order for actuating the accessory device. Thus, in some embodiments, the accessory device may automatically perform a service registration based on a one-to-one connection (e.g., direct connection, communication link where each device is exclusively connected to each other) with the electronic device. For example, the electronic device may establish the one-to-one connection with the accessory device. The accessory device may operate under an assumption that the electronic device includes service availability in the service registration module based on the one-to-one connection. Thus, the accessory device may automatically perform the service registration with the service registration module of the electronic device during link establishment between the electronic device and the accessory device. As an example, the accessory device may employ an Internet Protocol (IP) address, such as a link-local address or a mesh local address, to perform the automatic registration.

In some embodiments, the SRP server (executing on the electronic device) may identify that the service data associated with the service instance identifier of the accessory device is already stored in the cache. The SRP server may transmit (e.g., send) an indication of the service data associated with the service instance identifier to the accessory device. The service instance identifier may be a hash (e.g., hash value) that may include a fixed-size string of characters and numbers that unambiguously represent a piece of input data of any size. The accessory device may then determine if the service data is correct and/or up-to-date, and that there is no need to update the service data. For example, the accessory device may compare a hash of the service instance data cached or provided by the SRP server with a locally-computed hash associated with its own service instance data. If the hash cached or provided by the SRP server received from the electronic device matches the hash computed locally on its service instance data, then the accessory device may notify the SRP server that the service data it has cached matches its own service data. Alternatively, if the hash received from the SRP server is not a match, then the accessory device may indicate to the SRP server that its cached data is out-of-date or stale, and therefore not usable. As such, embodiments described herein may enable the service registration module to efficiently enable service discovery and/or access of services associated with the accessory devices on the wireless mesh network.

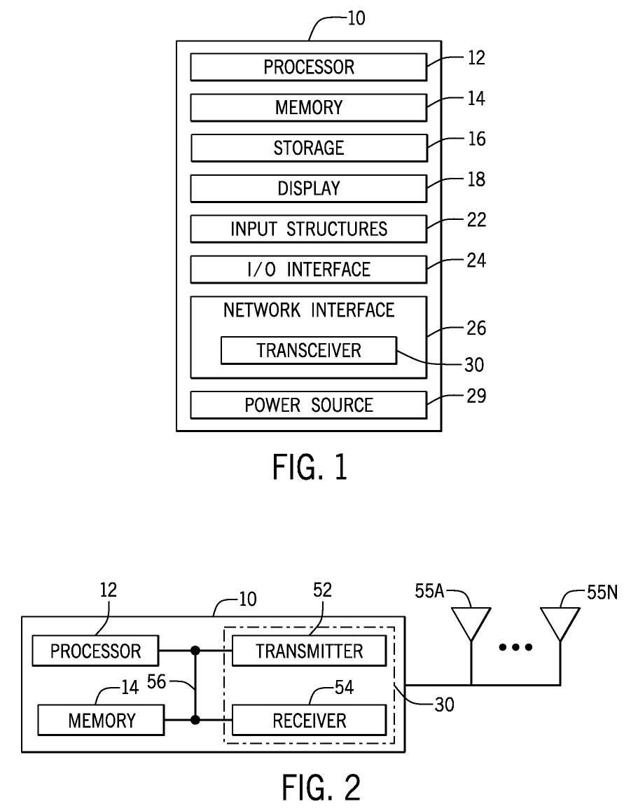

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. In some embodiments, the electronic device 10 may include a Thread device, such as a Thread on mobile device (e.g., any suitable electronic device having a Thread radio). For example, the electronic device 10 may include a sleepy router or a full router. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, a remote control device (e.g., that may wirelessly control another electronic device), and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH network, a local area network (LAN) or wireless local area network (WLAN), such as a network employing one of the IEEE 802.11x family of protocols (e.g., WI-FI), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, Long Term Evolution (LTE) cellular network, Long Term Evolution License Assisted Access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX), mobile broadband Wireless networks (mobile WIMAX), asynchronous digital subscriber lines (e.g., ADSL, VDSL), digital video broadcasting-terrestrial (DVB-T) network and its extension DVB Handheld (DVB‐H) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. As an example, the transceiver 30 may support transmission and/or reception of wireless mesh network signals, including Thread signals, to enable communication with a wireless mesh network, including a Thread network. The power source 29 of the electronic device 10 may include any suitable source of power, such as a rechargeable lithium polymer (Li-poly) battery and/or an alternating current (AC) power converter.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The electronic device 10 may include the transmitter 52 and/or the receiver 54 that respectively enable transmission and reception of signals between the electronic device 10 and an external device via, for example, a network (e.g., including base stations or access points) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

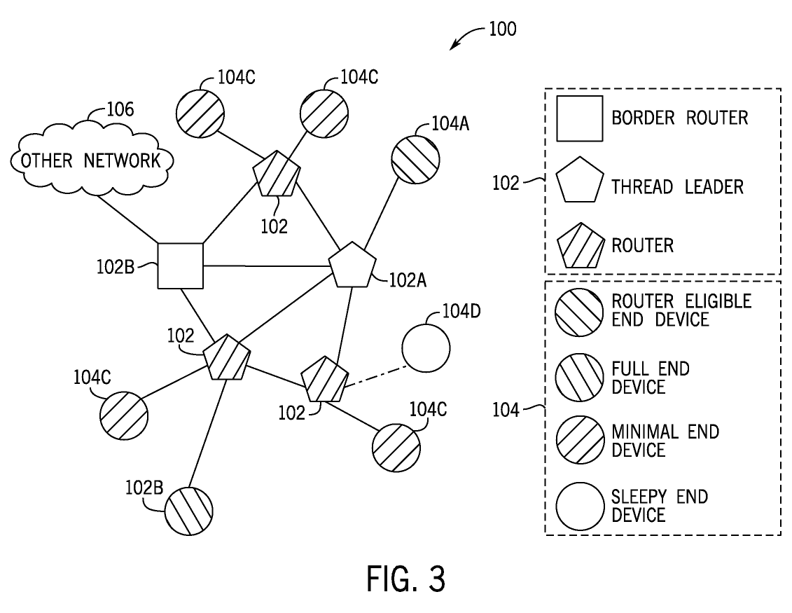

FIG. 3 is a schematic diagram of a wireless network 100 to which the electronic device 10 may be coupled. In particular, the wireless network 100 may include a wireless mesh network or a Low-Rate Wireless Personal Area Network (LR-WPAN), and, even more particularly, a Thread network. While the techniques described herein may be described with respect to the Thread network, it should be noted that the techniques may be utilized with other types of wireless networks, including, but not necessarily limited to, any IEEE Standard 802.15.4 network, such as a ZigBee network. For example, the techniques of the present disclosure may be utilized in a wireless mesh network, which generally refers to a wireless network that utilizes a mesh topology. For instance, a wireless mesh network may follow a WLAN topology in which the nodes (e.g., devices coupled to the mesh network) couple directly, dynamically, and/or non-hierarchically to other nodes (e.g., as many nodes as possible) and cooperate with one another to route data to and from devices. Wireless mesh networks include, but are not limited to, IEEE Standard 802.15.4 networks.

The wireless network 100 includes several nodes (e.g., routers 102 and accessory devices 104) that are coupled to one another as illustrated in FIG. 3. Each of the nodes may include an electronic device that is part of the wireless network 100. As illustrated, there are several types of nodes in the wireless network 100. Depending on the capabilities of the electronic device 10, the electronic device 10 may be one or more of any of the types of nodes. The particular types of nodes included in the wireless network 100 include routers 102 (collectively referring to routers 102 (e.g., routers that are not further classified as discussed below), thread leader 102A, and border router 102B) and the accessory devices 104 (collectively referring to accessory devices 104A, 104B, 104C, 104D). The routers 102 include nodes that forward packets for network devices, provide secure commissioning services for devices attempting to join the wireless network 100, and keep their transceiver(s) enabled at all times. The accessory devices 104 (e.g., end devices) include nodes that do not forward packets for other network devices, communicate (primarily) with a single router 102, and may disable their transceiver(s) to reduce power. As discussed below, the routers 102 and some accessory devices 104 may also be classified as full Thread devices, while other accessory devices 104 may be classified as minimal Thread devices. A full Thread device may always have its radio on, maintain IPv6 address mappings, and subscribe to an all-routers multicast address. Minimal Thread devices may not subscribe to the all-routers multicast address and forward their messages to a router 102 (or an accessory device 104 that is functioning as a router 102).

Within the classification of the routers 102, there may be several types of routers 102. For example, a router 102 may include a thread leader 102A, which manages the other routers in the wireless network 100. A router 102 may also include a border router 102B, which is a device that can forward data to another network 106, such as a network other than a Thread network (e.g., a Wi-Fi® network). The routers 102 may include full Thread devices.

Within the classification of the accessory devices 104, there are router eligible end devices 104A, full end devices 104B, minimal end devices 104C, and sleepy end devices 104D. Router eligible end devices 104A and full end devices 104B may include full Thread devices. More specifically, router eligible end devices 104A may include end devices 104 that can be promoted to function as a router 102, while full end devices 104B may include end devices 104 that are full Thread devices but cannot be promoted to be a router 102. Minimal end devices 104C and sleepy end devices 104D may include minimal Thread devices. In particular, a minimal end device 104C does not need to poll for messages sent from the router 102 to which the minimal end device 104C is coupled, and the minimal end device’s 104C transceiver may always be on. A sleepy end device 104D may include an end device 104 that is typically in sleep and wakes up occasionally to poll for messages from the router 102 to which it is coupled. In an embodiment, the sleepy end device 104D may be woken at any time during sleep, for example, by the electronic device 10. In an embodiment, the electronic device 10 may be a device capable of routing (e.g., a router 102, a router eligible end device 104A, a full end device 104B, and so on). As will be described in further detail below, the electronic device 10 may establish a connection with the accessory devices 104 to enable service discovery, service registration, and/or server access by employing a cache in a service registration module of the electronic device 10.

The wireless network 100 may be implemented indoors (e.g., within a dwelling or office space), outdoors, or both. The nodes may include electrical devices including, but not limited to, the electronic devices listed above that the electronic device 10 may be. For instance, the nodes (which include the electronic device 10) may be a phone, tablet, computer, a portable electronic or handheld electronic, a wearable electronic device, a smart speaker, home automation equipment (including, but not limited to switches, outlets, controllers, irrigation or sprinkler system equipment, sensors, lights, thermostats), a smart appliance, a smart door lock, wireless routers, network extenders, or power equipment), or any combination thereof.

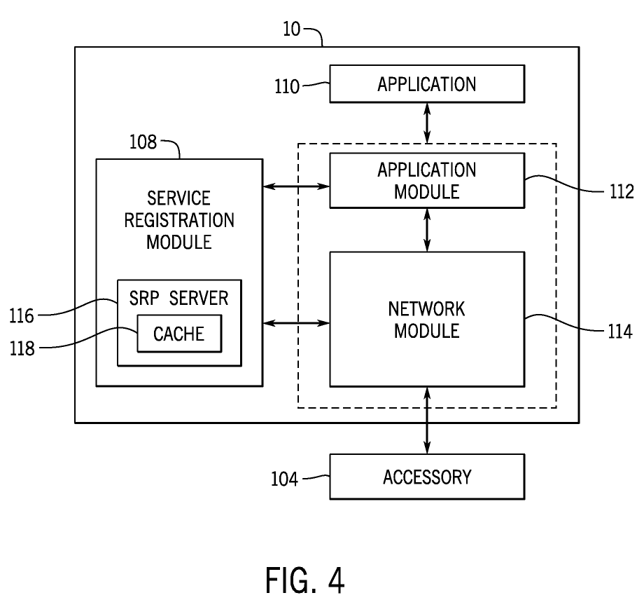

FIG. 4 is a block diagram of the electronic device 10 of FIG. 1 having a service registration module 108 to facilitate discovery and/or access of services of network devices, such as the routers 102 and/or the accessory device 104 on the network 100 (e.g., the wireless mesh network). It should be noted that the electronic device 10 may communicate with a single accessory device 104 or a single router device 102 communicate with multiple accessory devices 104. In some embodiments, the electronic device 10 may execute (e.g., run, launch) an application 110 that may communicatively couple with and/or interact with the accessory devices 104 (e.g., via a graphical user interface). The electronic device 10 may store the application 110 in the memory 14 of the electronic device 10 and execute the application 110 using the processor 12 of the electronic device 10. In some embodiments, the application 110 may include a smart home application, a smart appliance application, a home network application, and so on.

The electronic device 10 may also employ an application (e.g., Matter) module 112, a network (e.g., Thread) module 114, and/or a service registration (e.g., Service Registration Protocol (SRP)/Multicast Domain Name System (mDNS)) module 108 to communicate with the accessory devices 104 on the network 100. The application module 112 may define an application layer of an Open Systems Interconnection (OSI) model. That is, the application module 112 may define one or more protocols and one or more rules that enable devices (e.g., the electronic device 10, the routers 102, the accessory devices 104) to communicate with one another. The application module 112 may provide a framework for device discovery, control, and/or communication to enable seamless interaction between the devices (e.g., irrespective of underlying network technology, such as Ethernet, Wi-Fi, and Thread). For example, the application module 112 may provide a standard application programming interface (API) for device communication and control.

The network module 114 may operate at a network layer (e.g., over Internet Protocol version 6 (IPv6) of the OSI model and enable creation (e.g., formation) of the network 100 and/or management, such as routing, on the network 100 between the electronic device 10, the routers 102, and/or the accessory devices 104. The network module 114 may enable the electronic device 10, the routers 102, and/or the accessory devices 104 to exchange data across the network 100. Further, the service registration module 108 may facilitate discovery and/or registration of services corresponding to devices on the network 100. Additionally, the service registration module 108 may employ mDNS to enable other devices on the network 100 to query for available services. For example, mDNS may include a cache that may store service data, which may include datasets storing a name of service, a type of service, and/or additional information facilitating the use of instances of the service. Each dataset is identified by a service instance identifier. The service registration module 108 may employ mDNS for device name resolution and multicast queries.

As an example, the electronic device 10 may execute the application 110 to communicate with an accessory device 104 of the accessory devices 104 on the network 100 (e.g., Thread network set up by the network module 114). The application 110 may employ the application module 112 to discover and interact with the accessory device 104, such as by sending a discovery request or an initiation command. The application module 112 may then request a service instance identifier associated with a service instance of the accessory device 104 from the service registration module 108. The service registration module 108 may provide (e.g., return) the service data associated with the service instance identifier of the accessory device 104 to the application module 112 to enable the application module 112 to access the service of the accessory device 104 using the network module 114.

As an example, the service registration module 108 may include an SRP server 116 that may include a cache 118 (e.g., storage that holds frequently accessed data). In some embodiments, the cache 118 may be a part of the SRP server 116. In some embodiments, the cache 118 may be external to the SRP server 116 and accessible by the SRP server 116. The SRP server 116 may include a DNS authoritative name server that may manage the accessory devices 104 and their associated services on the wireless network 100. The accessory devices 104 may register their services with the SRP server 116 through SRP (e.g., protocol employed to register and/or update services in the SRP server 116). It should be noted that each of the accessory devices 104 may be associated with one or more instances of one or more services (e.g., a single instance of a single service or multiple instances of multiple services). It should be noted that each service may be identified by a service type and each instance may be identified by a service instance identifier, which may include the service type and a unique identifier.

Additionally or alternatively, the accessory devices 104 may initiate service discovery by employing DNS queries. The cache 118 may include an authoritative DNS database that stores service instance identifiers (e.g., as DNS records) associated with the service instances. For example, the accessory devices 104 may register their associated services (e.g., their respective service instances) to the SRP server 116 and the service registration module 108 may generate a list that includes service data associated with services and store the list in the cache. In some embodiments, the list may include information associated with the accessory device 104, such as an Internet Protocol (IP) address, a per-device host name, and/or services provided by the accessory device 104.

In this manner, the service registration module 108 may enable discovery of the services stored in the cache 118 by the accessory devices 104 on the wireless network 100. Further, in some embodiments, the service registration module 108 may identify whether particular service data associated with a particular service instance identifier associated with a service instance is stored in the cache 118. For example, the service registration module 108 may check the cache 118 to identify whether a valid and/or applicable registration of the service is stored. If the service data of the particular service is stored in the cache 118, then the service registration module 108 may refrain from advertising the service. Therefore, the service registration module 108 may enable on demand performance of service registration by identifying whether the service data is stored in the cache 118.

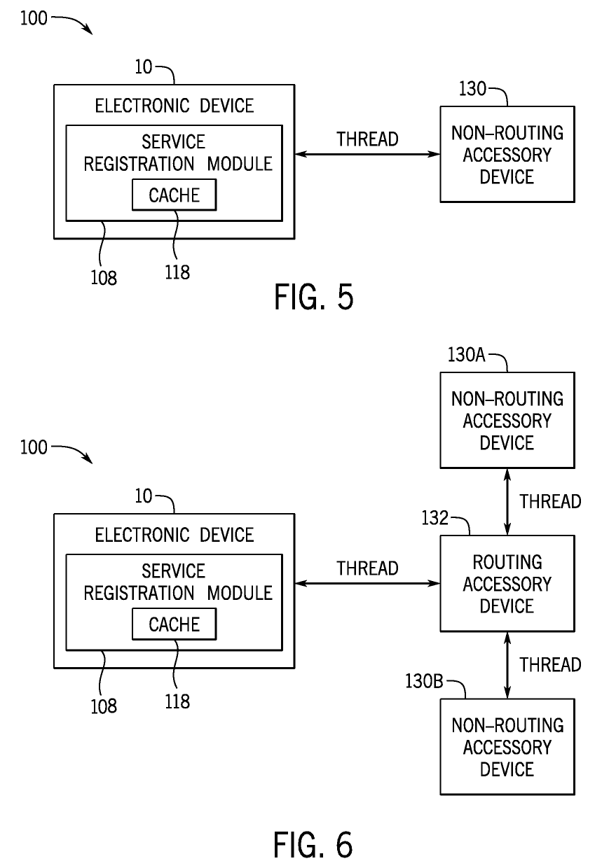

Moreover, in some embodiments, the accessory devices 104 may automatically perform a service registration with the SRP server 116 of the service registration module 108 in response to a one-to-one connection (e.g., direct connection, communication link where each device is exclusively connected to each other) with one another. Additional details regarding the cache 118 of the service registration module 108, on-demand service registration based on service advertising, and automatic registration of the accessory devices 104 to the SRP server 116 will be described below with respect to FIGS. 5-9.

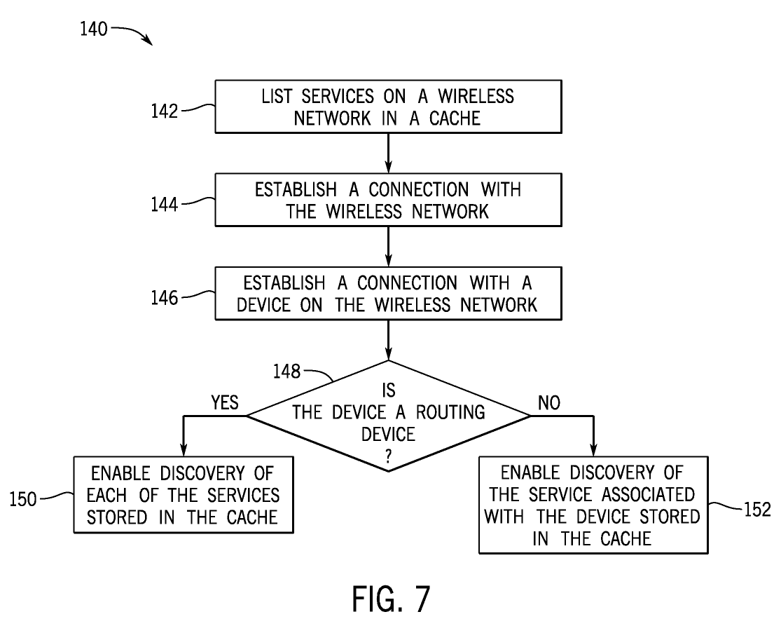

With the foregoing in mind, FIG. 5 is a block diagram of the electronic device 10 of FIG. 1 including the service registration module 108 with the cache 118 to enable discovery of a service by a non-routing accessory device 130 (e.g., the sleepy end device 104D) of FIG. 4. As will be described in further detail below with respect to FIG. 7, when the electronic device 10 establishes the connection (e.g., communicatively couples) with the non-routing accessory device 130, then the service registration module 108 may enable discovery of the service associated with the non-routing accessory device 130. To further explain, the electronic device 10 may retrieve the service data from the cache 118 to provide to the non-routing accessory device 130 to enable discovery. The non-routing accessory device 130 may then register for the service, having identified the service using the service instance identifier.

As an alternative example, FIG. 6 is a block diagram of the electronic device of FIG. 1 including the service registration module 108 with the cache 118 to enable discovery of each service on the wireless mesh network by a routing accessory device 132 (e.g., the router eligible end device 104A, the full end device 104B). As will be described in further detail below with respect to FIG. 7, when the electronic device 10 establishes a connection (e.g., communicatively couples) with the routing accessory device 132, the service registration module 108 may enable discovery of each of the services stored in the cache 118 and on the wireless network 100. For example, a first non-routing accessory device 130A and a second non-routing accessory device 130B may also be communicatively coupled to the wireless network 100. Thus, a service instance identifier associated with the first non-routing accessory device 130A and a service instance identifier associated with the second non-routing device 130B and/or any other suitable device connected to the wireless network 100 that is stored in the cache 118 may be provided to the routing accessory device 132 to enable discovery.

FIG. 7 is a flow diagram of a process 140 for the electronic device 10 of FIG. 1 to enable discovery of the services via the cache 118. Any suitable device (e.g., a controller) that may control components of the electronic device 10, such as the processor 12 or the transceiver 30, may perform the process 140. In some embodiments, the process 140 may be implemented by executing instructions stored in a tangible, non-transitory, computer-readable medium, such as the memory 14 or the storage 16, using the processor 12 or the transceiver 30. For example, the process 140 may be performed at least in part by one or more software components (e.g., the service registration module 108, application module 112, the network module 114) such as an operating system of the electronic device 10, one or more software applications of the electronic device 10, and the like. For example, the process 140 may be performed at least in part by the service registration module 108. That is, the processor 12, implementing or executing the service registration module 108 may perform the process 140 described herein. While the process 140 is described using steps in a specific sequence, it should be understood that the present disclosure contemplates that the described steps may be performed in different sequences than the sequence illustrated, and certain described steps may be skipped or not performed altogether.

As described herein, the accessory devices 104, 130, 132 may register services with the SRP server 116 of the service registration module 108. For example, the accessory devices 104, 130, 132 may register the services by providing service data associated with a service instance identifier (e.g., name of service, type of service, unique identifier associated with the service instance) to the service registration module 108. As such, at process block 142, the processor 12 lists the services on the wireless network 100 in the cache 118. For example, each entry in the list may include the service data including the service instance identifier and its associated service. In some embodiments, the list may also include device identifiers for those devices that are associated with the service instances. For example, the device identifiers may include a network address, a Media Access Control (MAC) address, an Internet Protocol (IP) address, a link-local address, a mesh local address, and so on. The cache 118 may include a temporary storage within the SRP server 116 of the service registration module 108 that enables efficient retrieval of the service instance identifiers and/or discovery of the accessory devices 104, 130, 132 on the wireless network 100.

It should be noted that the service instances stored in the cache 118 may be discoverable based on the electronic device 10 being communicatively coupled to the wireless network 100 (e.g., and not discoverable when the electronic device 10 is not communicatively coupled to the wireless network 100). At process block 144, the processor 12 establishes a connection with the wireless network 100. For example, the processor 12 may initiate a scan for nearby nodes (e.g., mesh nodes) using a suitable communication protocol (e.g., Wi-Fi, Thread, and so on) and establish the connection with a node of the nearby nodes. Further, at process block 146, the processor 12 establishes a connection with a device (e.g., the accessory device 104, the non-routing accessory device 130, the routing accessory device 132) on the wireless network 100. At process block 148, the processor 12 determines whether the device is the routing accessory device 132. As an example, the processor 12 may receive device information (e.g., device type) and/or network data associated with the device. In some embodiments, the routing accessory device 132 may provide an indication of whether it is the routing device. The processor 12 may then analyze the device information and the network data to determine whether the device is the routing accessory device 132. If the processor 12 determines that the device is the routing accessory device 132, the processor 12 proceeds to process block 150.

At process block 150, the processor 12 enables discovery of each of the service instances stored in the cache 118. For example, the processor 12 may provide the list of the service instances, which may include the service instance identifiers associated with each service instance, to the device. To further explain, the processor 12 may make each of the service instances connected to the wireless network 100 discoverable to the device. In this manner, the device may establish a connection and/or interact with each of the service instances provided via the list from the cache 118 based on the service data and/or the service instance identifiers.

With the foregoing in mind, and referring back to process block 148, if the processor 12 determines that the device is the non-routing accessory device 130, such as a sleepy WED device (e.g., sleepy end device that may be woken up at any time during sleep), the processor 12 proceeds to process block 152. At process block 152, the processor 12 enables discovery of the service instance(s) associated with the device stored in the cache 118. That is, the processor 12 may enable discovery of the service instance(s) specific to the device (e.g., and not the other service instances stored in the cache 118).

It should be noted that the SRP server 116 may be unaware of the presence of the accessory devices 104, 130, 132. For example, the SRP server 116 may be unaware of the presence of the accessory device 104, 130, 132 until the accessory devices 104, 130, 132 contact the SRP server 116. To prompt the accessory devices 104, 130, 132 to register their service instances with the SRP server 116, the electronic device 10 may employ the SRP server 116 to advertise an SRP service that may or may not be detected by the accessory devices 104, 130, 132. For example, the electronic device 10 may employ the SRP server 116 to advertise the SRP service in a network-wide dataset distributed by an infrastructure of the wireless network 100. However, simultaneous registration attempts to the SRP server 116 from several of the accessory devices 104, 130, 132 based on the advertising may cause network congestion and increased latency in network communication on the wireless network 100. Thus, it may be desirable to reduce a number of registration attempts to the SRP server 116 to reduce network congestion and latency. For example, the electronic device 10 may determine on a network-wide basis whether or not to advertise the SRP service based on whether the service data is stored in the cache 118 or is not stored in the cache 118.

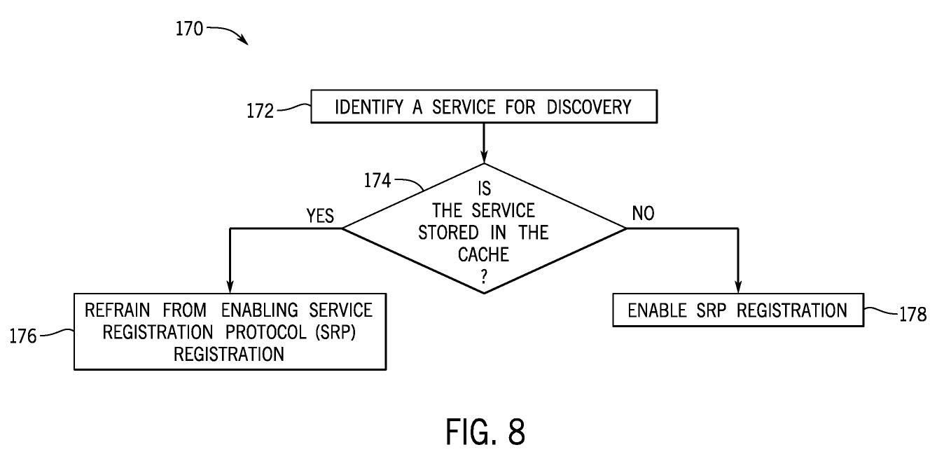

Thus, to reduce network congestion and latency, FIG. 8 is a flow diagram of a process 170 for the electronic device 10 of FIG. 1 to identify whether service data associated with a service instance is stored in the cache 118. Any suitable device (e.g., the controller) that may control components of the electronic device 10, such as the processor 12 or the transceiver 30, may perform the process 170. In some embodiments, the process 170 may be implemented by executing instructions stored in a tangible, non-transitory, computer-readable medium, such as the memory 14 or the storage 16, using the processor 12 or the transceiver 30. For example, the process 170 may be performed at least in part by one or more software components (e.g., the service registration module 108 including the SRP server 116, application module 112, the network module 114) such as an operating system of the electronic device 10, one or more software applications of the electronic device 10, and the like. For example, the process 170 may be performed at least in part by the service registration module 108. That is, the processor 12, implementing or executing the service registration module 108 may perform the process 170 described herein. While the process 170 is described using steps in a specific sequence, it should be understood that the present disclosure contemplates that the described steps may be performed in different sequences than the sequence illustrated, and certain described steps may be skipped or not performed altogether.

At process block 172, the processor 12 identifies a service for discovery. That is, the processor 12 may identify the service that the processor 12 may seek to establish a connection with. For example, the processor 12 may identify the service based on a pre-defined list of desired services (e.g., a speaker searching for a music streaming service, a smart home hub searching for a light bulb, and so on), a user input (e.g., a user selects a particular service), receiving a request or indication for the service from an accessory device 130, 132, and/or based on a function of the service. Further, the application module 112, as executed by the processor 12, may provide a list of service instances (e.g., including a service instance associated with the service) to actuate, employ, or otherwise use. Moreover, the application module 112 may transmit a request for a service instance identifier of the service instance to the service registration module 108. The request may include the service instance identifier to query for service data associated with the service instance identifier.

At process block 174, the service registration module 108, as executed by the processor 12, determines whether the service instance is stored in the cache 118 (e.g., based on the request from the application module 112). For example, the service registration module 108 may search the list including service data associated with the service instances stored in the cache 118 to identify whether the service instance is stored. To further explain, the service registration module 108 may check the cache 118 to identify whether a valid and/or applicable registration of the service instance is stored. If the processor 12 determines (e.g., based on the service registration module 108) that the service data associated with the service instance is stored in the cache 118, the processor 12 proceeds to process block 176. At process block 176, the processor 12 refrains from (e.g., avoids) enabling SRP registration (e.g., with the SRP server 116) or advertising the SRP service. For example, the processor 12 may suppress the advertising (e.g., of the SRP service) for service registration on the wireless network 100. In this manner, a number of accessory devices 104, 130, 132 may be prevented from performing SRP registration with the SRP server 116, which may reduce network congestion and latency in network communication. With the foregoing in mind, and referring back to process block 174, if the processor 12 determines that the service data associated with the service instance is not stored in the cache 118, the processor 12 proceeds to process block 178. At process block 178, the processor 12 enables SRP registration with the SRP server 116 (e.g., with the SRP server 116) and/or advertises the SRP service. For example, the processor 12 may advertise the SRP service (e.g., by employing the SRP server 116 to advertise the SRP service to enable service discovery).

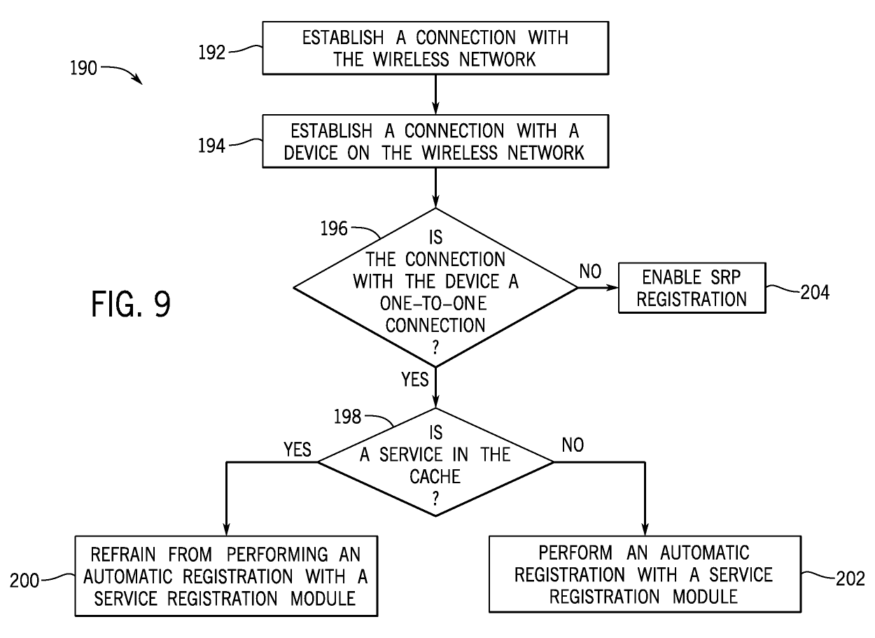

The accessory devices 104, 130, 132 may perform service registration in response to service advertising by the electronic device 10 (e.g., after the SRP server 116 advertises the SRP service on the wireless network 100), which may increase latency and network overhead. Accordingly, FIG. 9 is a flow diagram of a process 190 for the electronic device 10 of FIG. 1 to automatically perform service registration. Any suitable device (e.g., the controller) that may control components of the electronic device 10, such as the processor 12 or the transceiver 30, may perform the process 190. In some embodiments, the process 190 may be implemented by executing instructions stored in a tangible, non-transitory, computer-readable medium, such as the memory 14 or the storage 16, using the processor 12 or the transceiver 30. For example, the process 190 may be performed at least in part by one or more software components (e.g., the service registration module 108, application module 112, the network module 114) such as an operating system of the electronic device 10, one or more software applications of the electronic device 10, and the like. For example, the process 190 may be performed at least in part by the service registration module 108. That is, the processor 12, implementing or executing the service registration module 108 may perform the process 190 described herein. While the process 190 is described using steps in a specific sequence, it should be understood that the present disclosure contemplates that the described steps may be performed in different sequences than the sequence illustrated, and certain described steps may be skipped or not performed altogether.

At process block 192, the processor 12 establishes a connection (e.g., communicatively couples) with the wireless network 100. Moreover, at process block 194, the processor 12 establishes a connection (e.g., communicatively couples) with a device (e.g., the accessory device 104, 130, 132) on the wireless network 100. At process block 196, the processor 12 determines if the connection with the device is a one-to-one connection (e.g., direct connection). In some examples, the one-to-one connection may include a communication link where each device (e.g., the electronic device 10 and the device) is exclusively connected to each other. In additional or alternative examples, the one-to-one connection may include the communication link where the electronic device 10 is only connected to the device, while the device is connected to the electronic device 10 and one or more additional devices (e.g., additional accessory devices). If the processor 12 determines that the connection with the device is the one-to-one connection, the processor 12 proceeds to process block 198.

At process block 198, the processor 12 determines if a service instance is in the cache 118. If the processor 12 determines that service data associated with the service instance is in the cache 118, the processor 12 proceeds to process block 200. For example, the processor 12 may identify the service instance in the cache 118 based on a service instance identifier associated with the service instance and/or the device. In some embodiments, the processor 12 may compare the service instance identifier or a network address (e.g., an Internet Protocol (IP) address), stored in the cache 118 (e.g., and provided in the indication) to the service instance identifier or the IP address of the service instance. In some embodiments, the processor 12 may compare device identifiers for those devices that are associated with the service. For example, the device identifiers may include a network address, a Media Access Control (MAC) address, an Internet Protocol (IP) address, a link-local address, a mesh local address, and so on. At process block 200, the processor 12 refrains from performing an automatic registration with the service registration module 108. For example, if the electronic device 10 identifies the service data associated with the service (e.g., and its associated service instance identifier) is already stored in the cache (e.g., based on the process 170) then the electronic device 10 may refrain from advertising the service. In some examples, the electronic device 10 may communicate that information to the accessory device 104. With the foregoing in mind, and referring back to process block 198, if the processor 12 determines that the service data associated with the service instance is not in the cache 118, the processor 12 proceeds to process block 202.

At process block 202, the processor 12 performs automatic registration with the SRP server 116 of the service registration module 108 (e.g., with the accessory device 104, 130, 132 that has a one-to-one connection with the processor 12 or the SRP server 116). For example, the accessory device 104 may operate under an assumption that the electronic device 10 includes service availability in the service registration module 108. The processor 12 may perform the service registration during a link establishment phase (e.g., while forming a direct communication link between the electronic device 10 and the accessory device 104). As an example, the accessory device 104 may include a network address, such as an Internet Protocol (IP) address, a link-local address, and/or a mesh local address, and the processor 12 may perform the automatic registration of the accessory device 104 using the network address of the accessory device 104. With the foregoing in mind, and referring back to process block 196, if the processor 12 determines the connection is not a one-to-one connection, the processor 12 proceeds to process block 204. At process block 204, the processor 12 enables SRP registration or advertises the SRP service. For example, based on the one-to-one connection, the processor 12 may advertise the SRP service for the device (e.g., the single accessory device 104, 130, 132 that the electronic device 10 is communicatively coupled to). However, it should be noted that when the processor 12 is communicatively coupled to several accessory devices 104, 130, 132, the processor 12 may advertise all cached services instances in the cache 118 that are valid on the wireless network 100 that the processor 12 caused the electronic device 10 to communicatively couple to.

In some embodiments, if the electronic device 10 identifies the service data associated with the service instance (e.g., and its associated service instance identifier) is already stored in the cache (e.g., based on the process 170) then the electronic device 10 may communicate that information to the accessory device 104. The electronic device 10 may transmit an indication to the device indicative of the service instance being already stored in the cache 118. For example, the electronic device 10 may send service information to the accessory device 104 that may include version information, settings, or the information associated with the service instance. The accessory device 104, 130, 132 may determine if the service information is correct and/or up-to-date by determining if the service information correlates to or matches with its own service information associated with the service instance. If so, the accessory device 104 may send an indication that the service information is correct and/or up-do-date (e.g., by sending a bit to a first predetermined value, such as a high value or a low value to the electronic device 10), and that there is no need to adjust the service information. Accordingly, the accessory device 104, 130, 132 may verify that the service information matches and/or refrain from performing automatic service registration based on the verification. If the service information sent by the electronic device 10 that was stored in the cache 118 does not correlate to or match the corresponding service information stored in the accessory device 104, the accessory device 104 may send an indication that the service information is not correct and/or up-to-date (e.g., by sending the bit to a second predetermined value, such as a low value or a high value to the electronic device 10).

In some embodiments, the accessory device 104 may send the correct or up-to-date service information to the electronic device 10, and the electronic device 10 may update its service information using the up-do-date service information sent by the accessory device 104. In additional or alternative embodiments, the accessory device 104 may send its service information that does not match the service information sent by the electronic device 10, so only those fields of the service information are sent to the electronic device 10. The electronic device 10 may then update those fields sent by the accessory device 104. It should be noted that the electronic device 10 may perform a registration check with the device it is directly connected to (e.g., and not any additional devices connected to the device).

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The present disclosure contemplates that, in some embodiments, data used by network reachability monitoring processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with network reachability monitoring processes, should attempt to comply with well-established privacy policies and/or privacy practices.

1. One or more tangible, non-transitory computer-readable media storing instructions that, when executed by processing circuitry of an electronic device, are configured to cause the processing circuitry to:
store a list of one or more services registered to one or more accessory devices in a cache of a server;
cause the electronic device to communicatively couple with an accessory device on a wireless network;
determine the accessory device is a routing device or a non-routing device;
enable discovery of each of the one or more services in the list and connected to the wireless network based on the accessory device being the routing device; and
enable discovery of a service of the one or more services associated with the accessory device based on the accessory device being the non-routing device.

2. The one or more tangible, non-transitory computer-readable media of claim 1, wherein the instructions, when executed by the processing circuitry, cause the processing circuitry to register the one or more services associated with the one or more accessory devices with the server.

3. The one or more tangible, non-transitory computer-readable media of claim 1, wherein the server comprises a Service Registration Protocol server.

4. The one or more tangible, non-transitory computer-readable media of claim 1, wherein the instructions, when executed by the processing circuitry, cause the processing circuitry to enable discovery of the each of the one or more services or the service based on the electronic device being connected to the wireless network.

5. The one or more tangible, non-transitory computer-readable media of claim 1, wherein the instructions, when executed by the processing circuitry, cause the processing circuitry to identify a desired service of the one or more services for discovery.

6. The one or more tangible, non-transitory computer-readable media of claim 5, wherein the instructions, when executed by the processing circuitry, cause the processing circuitry to refrain from advertising the desired service in response to the desired service being stored in the cache.

7. The one or more tangible, non-transitory computer-readable media of claim 1, wherein the instructions, when executed by the processing circuitry, cause the processing circuitry to:
determine that an additional service associated with an additional accessory device is stored in the cache; and
automatically register the additional service based on establishing a one-to-one connection with the additional accessory device and the additional service not being stored in the cache.

8. The one or more tangible, non-transitory computer-readable media of claim 7, wherein the instructions, when executed by the processing circuitry, cause the processing circuitry to refrain from automatically registering the additional service based on the additional service being stored in the cache.

9. A method to be performed by processing circuitry of an electronic device comprising:
identifying a service for discovery;
determining that the service is stored in a cache of the electronic device;
refraining from enabling registration of the service based on the service being stored in the cache; and
enabling registration of the service based on the service not being stored in the cache.

10. The method of claim 9, wherein when the service is stored in the cache, the service is registered to an accessory device in a server comprising the cache.

11. The method of claim 10, wherein the server comprises a Service Registration Protocol (SRP) server.

12. The method of claim 10, comprising storing a list comprising the service and the accessory device in the cache.

13. The method of claim 9, comprising enabling discovery of the service based on the service being stored in the cache.

14. The method of claim 9, comprising enabling discovery of the service based on the service being stored in the cache and the electronic device being connected to a same wireless network as the service.

15. An electronic device comprising:
a transmitter;
a receiver;
processing circuitry coupled to the transmitter and the receiver, the processing circuitry configured to:
cause the electronic device to communicatively couple with an accessory device on a wireless network to establish a connection with the accessory device;
determine whether the connection with the accessory device is a one-to-one connection;
determine whether a service associated with the accessory device is stored in a cache of the electronic device;
perform an automatic registration of the service with a server based on the connection being the one-to-one connection and the service not being stored in the cache;
refrain from performing the automatic registration of the service with the server based on the service being stored in the cache; and
cause the transmitter to advertise the service based on the connection not being the one-to-one connection.

16. The electronic device of claim 15, wherein the one-to-one connection comprises an exclusive connection between the electronic device and the accessory device.

17. The electronic device of claim 15, wherein the processing circuitry is configured to perform the automatic registration based on the connection being the one-to-one connection during a link establishment phase.

18. The electronic device of claim 15, wherein the processing circuitry is configured to perform the automatic registration based on the connection being the one-to-one connection and based on a link-local address or a mesh local address.

19. The electronic device of claim 15, wherein the processing circuitry is configured to determine that service data associated with the service is stored in the cache of the electronic device based on a service instance identifier.

20. The electronic device of claim 19, wherein the processing circuitry is configured to cause the transmitter to transmit an indication to the accessory device that the service is stored in the cache.
